(19) United States
(12) Patent Application Publication
(10) Pub. No.: US 2026/0235916 A1
(43) Pub. Date: Aug. 13, 2026

(54) Color Semi-Transparent Partially Erasable Electronic Writing Film with Code Points and Use Thereof

(71) Applicant: Fushan ZHANG, Guangdong (CN)

(72) Inventors: Fushan ZHANG, Guangdong (CN); Shangying DENG, Guangdong (CN)

(73) Assignee: Fushan ZHANG, Guangdong (CN)

(21) Appl. No.: 19/049,143

(22) Filed: Feb. 10, 2025

(51) Int. Cl. G02F 1/137; C09J 9/02; C09J 11/04; C09J 11/06; C09J 175/14; C09K 19/36; C09K 19/52; C09K 19/54; G02F 1/1343

(52) U.S. Cl. CPC G02F 1/137; C09J 9/02; C09J 11/04; C09J 11/06; C09J 175/14; C09K 19/36; C09K 19/542; G02F 1/13439; C09K 2019/521; C09K 2219/03

(57) ABSTRACT

The color semi-transparent partially erasable electronic writing film with code points comprises: a first conductive layer, an intermediate layer and a second conductive layer which are stacked in sequence, wherein the intermediate layer is a liquid crystal layer containing a code-point carbon element capsule array, which is obtained by free filling of a cholesteric liquid crystal composition between the first conductive layer and the second conductive layer, followed by UV curing and integral forming. The cholesteric liquid crystal composition comprises the following raw materials in percent by mass: 75% to 85% of a nematic cholesteric liquid crystal, 1% to 10% of a code-point carbon element capsule, 4% to 15% of a UV adhesive and 0.1% to 0.3% of an isolation space powder. The first conductive layer and the second conductive layer are transparent conductive electrode film layers made of an indium tin oxide (ITO) or a conductive polymer.

### BACKGROUND OF THE INVENTION

### 1. Technical Field

The present invention belongs to the technical field of liquid crystal writing films and, in particular, relates to a color semi-transparent partially erasable electronic writing film with code points and use thereof.

### 2. Description of Related Art

Microcapsule display is a typical flexible liquid crystal display. By a microencapsulation technology, originally easy-to-flow liquid crystals are confined in a specific space to form microencapsulated liquid crystals, and the microencapsulated liquid crystals are then dispersed in a dispersant and applied to a flexible display panel to achieve flexible display.

Inside LCD screens, according to the way molecules are arranged, microencapsulated liquid crystals may be divided into three categories: nematic liquid crystals, smectic liquid crystals, and cholesteric liquid crystals. The cholesteric liquid crystals are flat and arranged in layers. The molecules in the layers are parallel to each other, and the long axes of the molecules are parallel to layer planes. If the directions of the long axes of the molecules in different layers vary slightly, these molecules are arranged into a spiral structure along the normal directions of the layers. The cholesteric liquid crystals are generally ester compounds formed by reacting cholesterol (main raw material) with certain organic acids (such as oleic acid, benzoic acid and nonanoic acid). Based on the characteristics of the above liquid crystal molecular materials, handwriting tablet manufacturers have developed a variety of electronic handwriting display devices.

For example: Patent document CN111323950A discloses a liquid crystal writing film structure with a calligraphy and painting copybook, including a carrier, an electrode, and a liquid crystal layer, wherein the liquid crystal layer is arranged in the carrier and includes cholesteric liquid crystals, and the carrier is a translucent material film; a dot matrix array (including a code dot matrix array) is laid on a front face or back face of the carrier and is integrally formed; when an intelligent pen is used to write on the carrier, an image formed by the dot matrix array is obtained and sent to an intelligent terminal, so as to identify the handwriting track of the intelligent pen; a detachable calligraphy and painting book is arranged on one side of the carrier; the calligraphy and painting book and the dot matrix array are integrally formed; a writing surface of the calligraphy and painting book does not contain carbon element. However, because the structure of the microencapsulated liquid crystals applied to a flexible display panel, as disclosed in this document, affects the contrast between a display area and a non-display area, the displayed content is unclear.

Patent document CN103424922A discloses an electronic display with a semitransparent back layer. The electronic display includes: electrically conductive layers; an active layer disposed between adjacent electrically conductive layers, the active layer including a cholesteric liquid crystal material; at least one transparent front substrate disposed in the vicinity of one of the electrically conductive layers near a front of the display; a semitransparent back layer that absorbs light that passes through the active layer, reflects gray light or light of a color and is light-transmitting; and an electronic circuit for applying a voltage to the electrically conductive layers, so as to enable at least one of erasing or writing on the active layer. However, the writing film disclosed in this document can only be partially erased by voltage, and there are problems such as incomplete erasing and high production cost. In addition, the writing film disclosed in this document has no storage function and can only be used for writing but not for transmission and storage. Because the structure of the microencapsulated liquid crystals applied to a flexible display panel on the display affects the contrast between a display area and a non-reality area, handwriting traces are unclear.

To achieve the transmission and storage functions, three PET substrates are required, which increases the production cost and also causes the problems such as bulging of the writing film and sensitivity reduction during use in the market. In view of the foregoing, the technical problem to be solved is to add a storage function to the device and also improve the clarity and contrast of handwriting on the display panel.

### BRIEF SUMMARY OF THE INVENTION

An objective of the present invention is to provide a color semi-transparent partially erasable electronic writing film with code points and use thereof, so as to solve the technical problems existing in the prior art, such as unclear display traces, no storage function, bulging of the writing film and sensitivity reduction during use.

In order to solve the above technical problems, the present invention provides the following technical solutions:

The present invention provides a color semi-transparent partially erasable electronic writing film with code points, comprising: a first conductive layer, an intermediate layer and a second conductive layer which are stacked in sequence, wherein the intermediate layer is a liquid crystal layer containing a code-point carbon element capsule array, which is obtained by free filling of a cholesteric liquid crystal composition between the first conductive layer and the second conductive layer, followed by UV curing and integral forming;
the cholesteric liquid crystal composition comprises the following raw materials in percent by mass: 75% to 85% of a nematic cholesteric liquid crystal, 1% to 10% of a code-point carbon element capsule, 4% to 15% of a UV adhesive and 0.1% to 0.3% of an isolation space powder;
the first conductive layer and the second conductive layer are transparent conductive electrode film layers made of an indium tin oxide (ITO) or a conductive polymer (such as PEDOT).

Preferably, the nematic cholesteric liquid crystal is an RGB color cholesterol single liquid crystal mixture, such as product HYLC-049 produced by Beijing Bayi Space LCD Technology Co., Ltd., where R represents red single crystal HYLC901, G represents green single crystal HYLC806, and B represents blue single crystal HYLC605. The RGB color cholesterol single liquid crystal mixture can be prepared by adding a chiral agent to cholesteric phase liquid crystals to prepare cholesteric phase liquid crystal R, cholesteric phase liquid crystal G and cholesteric phase liquid crystal B respectively, and adding a polymer additive to the cholesteric phase liquid crystal R, the cholesteric phase liquid crystal G and the cholesteric phase liquid crystal B respectively. The RGB color cholesterol single liquid crystal mixture has low power consumption, high definition and high response performance.

Preferably, the code-point carbon element is graphite and/or carbon black obtained through the combustion and gasification process of petroleum or natural gas; the code-point carbon element capsule is a microcapsule made by encapsulating the code-point carbon element in a water capsule shell material such as gelatin and/or glycerin, and the particle size of the microcapsule is 0.1-0.5 μm. Good glossiness and adhesion performance are achieved. For example, the code-point carbon element used is Mitsubishi (Japan) MA100 carbon black powder, which is further made into the code-point carbon element capsule.

Preferably, the UV adhesive is a polyurethane acrylic polymer, such as HYD8099 produced by Hongyangde Company or ETERCURE6101 produced by Eternal Materials Industry Co., Ltd., which is a synthetic material with extremely low viscosity, excellent flexibility and good adhesion.

Preferably, the isolation space powder is a white polydivinylbenzene polymer with a uniform particle size of 1-10 μm, and a coefficient of variation of at most 2.00%, for example, N07E26-10 produced by Suzhou NanoMicro Technology Co., Ltd., which has excellent dispersibility and can be efficiently dispersed in a solvent.

Preferably, the UV curing refers to curing by polymerization and cross-linking reaction under UV irradiation at a temperature of 30-40° C., a pressure of 4-5 MPa, and a UV intensity of 3.5-5cd, so as to achieve rapid curing and controllable reaction.

To further optimize the display effect, the cholesteric liquid crystal composition of the present invention further comprises 3% to 7% of a magnetic microcapsule (more preferably 5% to 7% of the magnetic microcapsule). The magnetic microcapsule enhances the stability of the structure and also improves the clarity and contrast of the handwriting through the unique physical properties of the magnetic microcapsule, thereby making the written content more vivid and easy to identify on the display.

Preferably, the cholesteric liquid crystal composition comprises: 80% of the nematic cholesteric liquid crystal, 8% of the code-point carbon element capsule, 5% of Hongyangde UV adhesive, 0.2% of the isolation space powder and 6.8% of the magnetic microcapsule.

The magnetic microcapsule is a microcapsule made by encapsulating a magnetic particle in a microcapsule. The magnetic particle comprises one or more of ferroferric oxide powder, ferrite powder, and alloy magnetic powder with a particle size of 0.1-3 μm. The preparation method of the magnetic microcapsule may be complex coagulation-water-in-oil interface method (for example, patent document CN105730082A), oil-in-water interface method (for example, patent document CN101609630A) and gelatin-gum arabic complex coagulation method (for example, patent document CN101927642A), or the like. The magnetic microcapsule prepared by the complex coagulation-water-in-oil interface method is preferred. For example, the magnetic microcapsule is CK7801 produced by Wuhan Institution of Advanced Technology (WIAT). The magnetic microcapsule can improve the blackness of the agglomerate, effectively improve the clarity and contrast of the handwriting on the display panel, and ensure long-term stable writing and erasing.

Further, the present invention further provides a color semi-transparent partially erasable electronic display with code points, comprising at least one first carrier layer and at least one second carrier layer, wherein the color semi-transparent partially erasable electronic writing film with code points is sandwiched between the first carrier layer and the second carrier layer; the first carrier layer is a transparent nano-sized PET conductive film, and the second carrier layer is a transparent or non-transparent nano-sized PET conductive film.

Preferably, in this case, the first conductive layer of the color semi-transparent partially erasable electronic writing film with code points may be a transparent conductive layer obtained by directly applying an indium tin oxide (ITO) or a conductive polymer (such as PEDOT) to an inner surface of the first carrier layer by; similarly, the second conductive layer may be a transparent conductive layer obtained by directly applying an indium tin oxide (ITO) or a conductive polymer (such as PEDO) to an inner surface of the second carrier layer.

Further preferably, as shown in FIG. 3, on an outer surface of the first carrier layer away from the first conductive layer or/and an outer surface of the second carrier layer away from the second conductive layer, or/and a surface of the first conductive layer or/and the second conductive layer facing the intermediate layer, a code-point carbon element is printed. The code-point carbon element has been described above. For example, Mitsubishi (Japan) MA100 carbon black powder is used. In this way, the clarity and contrast of the handwriting can be improved further, the more long-term stable writing and erasing functions of the writing film can be ensured, production cost is reduced, and the transmission and storage functions of the electronic display can be further enhanced. The code-point carbon element may be printed on the first carrier layer, the second carrier layer, the first conductive layer or/and the second conductive layer using gravure printing technology, and the coverage area of the code-point carbon element is at least 80% (more preferably at least 90%) of the total area of the printed layer.

Further, the outer surface of the second carrier layer of the color semi-transparent partially erasable electronic display with code points is also provided with a semi-transparent coating for absorbing light passing through the active layer, reflecting gray light or light of a certain color and transmitting light.

The semi-transparent partially erasable electronic display with code points in the present invention has an electronic circuit arranged between the first conductive layer and the second conductive layer, and a voltage is applied to the conductive layer to enable erasing or writing on the intermediate layer; the voltage is applied as a voltage pulse or a continuous voltage; when an intelligent pen is used to write on the intermediate layer through the conductive layers under a physical pressure, an track image formed by the code-point carbon element capsule array is obtained and sent to an intelligent terminal, thereby identifying the handwriting track of the intelligent pen.

The electronic display, in the form of a decorative electronic skin, is applied to the group consisting of: a cell phone, a laptop, a computer, a computer monitor, a computer mouse, a computer keyboard, a television set, an I-pod, an MP3 player, a PDA, a video game controller, a stereo sound, a radio, a CD player, a home appliance, a toy, a headset, a clock, a handheld electronic device, a key ring accessory, shoes, a wallet, a backpack, a briefcase, a computer case, a computer cover, jewelry, a watch, a bottle, a bottle cap, clothing, clothing decorations, furniture, furniture decorations, a mobile entertainment case, and combinations thereof.

Compared with the prior art, the present invention has the following advantages:

In the liquid crystal layer containing the code-point carbon element capsule array of the present invention, OID codes are integrally formed on the transparent conductive film, and in particular, the liquid crystal flipping is performed under the interaction of P type and N type by adopting the magnetic physics principle in a voltage-free manner, thereby achieving the partial erasing function of the display, and effectively solving the problems in the prior art, such as incomplete erasing during partial erasing and high production cost. The magnetic microcapsule can enhance the stability of the writing film structure and improve the clarity and contrast of the handwriting. Adding the code-point carbon element capsule to the cholesteric liquid crystal composition can achieve the transmission and storage functions of the electronic display. By printing the code-point carbon element on the first conductive layer or/and the second conductive layer, the problems such as bulging of the writing film and sensitivity reduction during use in the market.

### BRIEF DESCRIPTION OF THE SEVERAL VIEWS OF THE DRAWINGS

FIG. 1 is a schematic diagram of a layered color semi-transparent partially erasable electronic writing film with code points.

FIG. 2 is a schematic diagram of a layered color semi-transparent partially erasable electronic display with code points.

FIG. 3 is a schematic diagram of a layered color semi-transparent partially erasable electronic display with code points, having a code-point carbon element printed on an inner surface of a first conductive layer.

FIG. 4 is a schematic diagram of a layered color semi-transparent partially erasable electronic display with code points, having a code-point carbon element printed on an inner surface of a second conductive layer.

In the figures: 201—first conductive layer, 100—intermediate layer, 202—second conductive layer, 301—first carrier layer, 302—second carrier layer, 401—code-point carbon element.

### DETAILED DESCRIPTION OF THE INVENTION

In order to make the described objectives, features and advantages of the present invention more obvious and more understandable, the specific embodiments of the present invention are described in detail below in conjunction with the accompanying drawings. Those skilled in the art should appreciate that the embodiments are only used to illustrate the present invention, but not to limit the present invention. Any changes or modifications to the embodiments within the scope of the present invention should fall within the scope of the claims of the present invention.

### Example 1

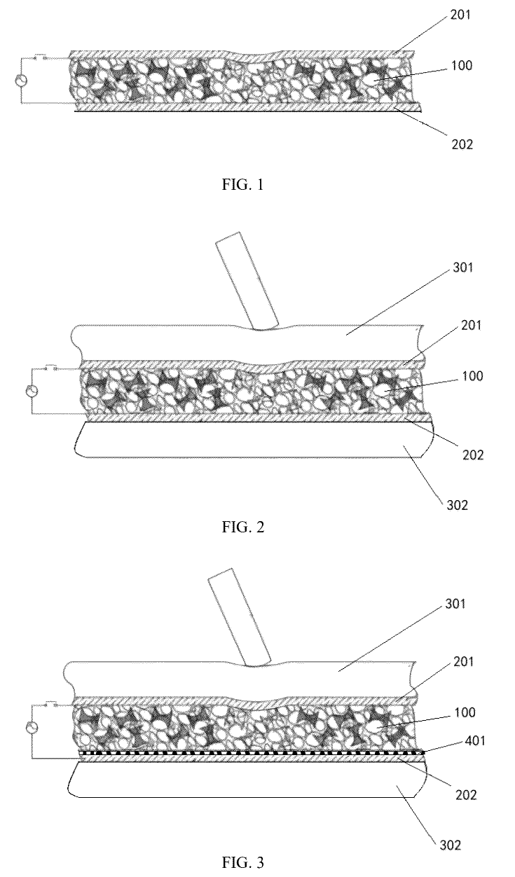

As shown in FIG. 1, a color semi-transparent partially erasable electronic writing film with code points comprises: a first conductive layer 201, an intermediate layer 100 and a second conductive layer 202 which are stacked in sequence. The intermediate layer 100 is a liquid crystal layer containing a code-point carbon element capsule array, which is obtained by free filling of a cholesteric liquid crystal composition between the first conductive layer 201 and the second conductive layer 202, followed by UV curing and integral forming. The UV curing is carried out by polymerization and cross-linking reaction curing under UV irradiation at a temperature of 35° C., a pressure of 4.5 MPa, and a UV intensity of 5cd in the presence of a photoinitiator and a sensitizer.

The cholesteric liquid crystal composition comprises: 80% of a nematic cholesteric liquid crystal (HYLC-049 produced by Beijing Bayi Space LCD Technology Co., Ltd.), 8% of a code-point carbon element capsule (FJ5111 produced by Xianghui Company), 5% of Hongyangde UV adhesive (HYD8099 produced by Hongyangde Company), 0.2% of an isolation space powder (N07E26-10 produced by Suzhu NanoMicro Technology Co., Ltd.) and 6.8% of a magnetic microcapsule (CK7801 produced by WIAT).

The first conductive layer 201 and the second conductive layer 202 are transparent conductive electrode film layers made of an indium tin oxide (ITO).

As shown in FIG. 2, a color semi-transparent partially erasable electronic display with code points comprises: on any one of a first carrier layer 301 and a second carrier layer 302, a color semi-transparent partially erasable electronic writing film with code points sandwiched between the first carrier layer 301 and the second carrier layer 302. The first carrier layer is a transparent nano-sized PET conductive film, and the second carrier layer 302 is a transparent nano-sized PET conductive film.

As shown in FIG. 3, in Example 2 which is based on Example 1, a layer of code-point carbon element 401 is evenly printed on the inner surface of the second conductive layer 202 facing the intermediate layer 100, and the coverage area of the code-point carbon element on the second conductive layer 202 is 95%.

in Example 3 which is based on Example 1, a layer of code-point carbon element 401 is evenly printed on the inner surface of the second conductive layer 202 facing the intermediate layer 100, and the coverage area of the code-point carbon element on the second conductive layer 202 is 80%.

Comparative Example 1 is a comparative example of Example 2 and differs from Example 2 in that the cholesteric liquid crystal composition in Comparative Example 1 comprises: 85% of a nematic cholesteric liquid crystal (HYLC-049 produced by Beijing Bayi Space LCD Technology Co., Ltd.), 8% of Hongyangde UV adhesive (HYD8099 produced by Hongyangde Company), 0.2% of an isolation space powder (N07E26-10 produced by Suzhu NanoMicro Technology Co., Ltd.) and 6.8% of a magnetic microcapsule (CK7801 produced by WIAT).

### Example 4

A color semi-transparent partially erasable electronic writing film with code points comprises: a first conductive layer 201, an intermediate layer 100 and a second conductive layer 202 which are stacked in sequence. The intermediate layer 100 is a liquid crystal layer containing a code-point carbon element capsule array, which is obtained by free filling of a cholesteric liquid crystal composition between the first conductive layer 201 and the second conductive layer 202, followed by UV curing and integral forming. The UV curing is carried out by polymerization and cross-linking reaction curing under UV irradiation at a temperature of 38° C., a pressure of 3.8 MPa, and a UV intensity of 4.6cd in the presence of a photoinitiator and a sensitizer.

The cholesteric liquid crystal composition comprises: 81% of a nematic cholesteric liquid crystal (HYLC-049 produced by Beijing Bayi Space LCD Technology Co., Ltd.), 5.8% of a code-point carbon element capsule (FJ5111 produced by Xianghui Company), 7% of Hongyangde UV adhesive (HYD8099 produced by Hongyangde Company), 0.2% of an isolation space powder (N07E26-10 produced by Suzhu NanoMicro Technology Co., Ltd.) and 6% of a magnetic microcapsule (CK7801 produced by WIAT).

a color semi-transparent partially erasable electronic display with code points comprises: on any one of a first carrier layer 301 and a second carrier layer 302, a color semi-transparent partially erasable electronic writing film with code points sandwiched between the first carrier layer 301 and the second carrier layer 302. The first carrier layer is a transparent nano-sized PET conductive film, and the second carrier layer is a transparent nano-sized PET conductive film. The first conductive layer 201 and the second conductive layer 202 are transparent conductive electrode film layers formed by applying an ITO on the inner surface of the first carrier layer 301 and the inner surface of the second carrier layer 302 respectively. A layer of code-point carbon element is evenly printed on the outer surface of the first carrier layer 301 away from the first conductive layer 201, and the coverage area of the code-point carbon element on the first carrier layer 301 is 92%.

### Example 5

A color semi-transparent partially erasable electronic writing film with code points comprises: a first conductive layer 201, an intermediate layer 100 and a second conductive layer 202 which are stacked in sequence. The intermediate layer 100 is a liquid crystal layer containing a code-point carbon element capsule array, which is obtained by free filling of a cholesteric liquid crystal composition between the first conductive layer 201 and the second conductive layer 202, followed by UV curing and integral forming. The UV curing is carried out by polymerization and cross-linking reaction curing under UV irradiation at a temperature of 30° C., a pressure of 5 MPa, and a UV intensity of 4.3cd in the presence of a photoinitiator and a sensitizer.

The cholesteric liquid crystal composition comprises: 75% of a nematic cholesteric liquid crystal (HYLC-049 produced by Beijing Bayi Space LCD Technology Co., Ltd.), 12.8% of a code-point carbon element capsule (FJ5111 produced by Xianghui Company), 5% of Hongyangde UV adhesive (HYD8099 produced by Hongyangde Company), 0.2% of an isolation space powder (N07E26-10 produced by Suzhu NanoMicro Technology Co., Ltd.) and 7% of a magnetic microcapsule (CK7801 produced by WIAT).

The first conductive layer 201 and the second conductive layer 202 are transparent conductive electrode film layers made of a conductive polymer PEDOT.

A color semi-transparent partially erasable electronic display with code points comprises: on any one of a first carrier layer 301 and a second carrier layer 302, a color semi-transparent partially erasable electronic writing film with code points sandwiched between the first carrier layer 301 and the second carrier layer 302. The first carrier layer is a transparent nano-sized PET conductive film, and the second carrier layer 302 is a non-transparent nano-sized PET conductive film. A layer of code-point carbon element is evenly printed on the inner surface of the first conductive layer 201 facing the intermediate layer 100, and the coverage area of the code-point carbon element on the first conductive layer 201 is 90%.

### Example 6 (without Magnetic Microcapsule)

As shown in FIG. 1, a semi-transparent partially erasable electronic writing film with code points comprises: a first conductive layer 201, an intermediate layer 100 and a second conductive layer 202 which are stacked in sequence. The intermediate layer 100 is a liquid crystal layer containing a code-point carbon element capsule array, which is obtained by free filling of a cholesteric liquid crystal composition between the first conductive layer 201 and the second conductive layer 202, followed by UV curing and integral forming. The UV curing is carried out by polymerization and cross-linking reaction curing under UV irradiation at a temperature of 40° C., a pressure of 4 MPa, and a UV intensity of 4.5cd in the presence of a photoinitiator and a sensitizer.

The cholesteric liquid crystal composition comprises: 83% of a nematic cholesteric liquid crystal (HYLC-049 produced by Beijing Bayi Space LCD Technology Co., Ltd.), 7% of a code-point carbon element capsule (FJ5111 produced by Xianghui Company), 8.8% of Hongyangde UV adhesive (HYD8099 produced by Hongyangde Company), and 0.2% of an isolation space powder (N07E26-10 produced by Suzhu NanoMicro Technology Co., Ltd.).

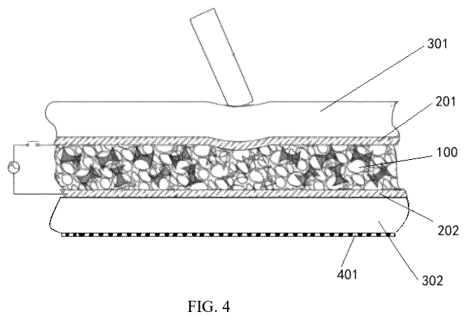

As shown in FIG. 4, a color semi-transparent partially erasable electronic display with code points comprises: on any one of a first carrier layer 301 and a second carrier layer 302, a color semi-transparent partially erasable electronic writing film with code points sandwiched between the first carrier layer 301 and the second carrier layer 302. The first carrier layer is a transparent nano-sized PET conductive film, and the second carrier layer is a non-transparent nano-sized PET conductive film. The first conductive layer 201 and the second conductive layer 202 are transparent conductive electrode film layers formed by applying an ITO on the inner surface of the first carrier layer 301 and the inner surface of the second carrier layer 302 respectively. A layer of code-point carbon element is evenly printed on the outer surface of the second carrier layer 302 away from the second conductive layer 202, and the coverage area of the code-point carbon element on the second carrier layer 302 is 95%.

### Experimental Test Example

An electronic circuit is arranged between the first conductive layer and the second conductive layer in the color semi-transparent local erasable electronic display with code points in Examples 1-6 and Comparative Example 1, and then an electronic control board, a battery, an ABS shell material, etc. are installed to make a finished product, and then the number of writing times and the partial erasing performance are tested.

TABLE 1
Percents of cholesteric liquid crystal compositions in Examples 1-6
and Comparative Example 1 and test results

| | Example | Example | Example | Example | Example | Example | Comparative |
|---|---|---|---|---|---|---|---|
| Description | 1 | 2 | 3 | 4 | 5 | 6 | Example 1 |
| Nematic | 80 | 80 | 80 | 81 | 78 | 82 | 85 |
| cholesteric | | | | | | | |
| liquid crystal, | | | | | | | |
| % | | | | | | | |
| Code-point | 8 | 8 | 8 | 5.8 | 9 | 7 | 0 |
| carbon | | | | | | | |
| element | | | | | | | |
| capsule, % | | | | | | | |
| Hongyangde | 5 | 5 | 5 | 7 | 5.8 | 8.8 | 8 |
| UV adhesive, | | | | | | | |
| % | | | | | | | |
| Isolation | 0.2 | 0.2 | 0.2 | 0.2 | 0.2 | 0.2 | 0.2 |
| space | | | | | | | |
| powder, % | | | | | | | |
| Magnetic | 6.8 | 6.8 | 6.8 | 6 | 7 | 0 | 6.8 |
| microcapsule, | | | | | | | |
| % | | | | | | | |
| Writing | Qualified | Qualified | Qualified | Qualified | Qualified | Qualified | Qualified |
| smoothness | | | | | | | |
| Percent of | 0 | 95 | 80 | 92 | 90 | 95 | 95 |
| printed code- | | | | | | | |
| point carbon | | | | | | | |
| element, % | | | | | | | |
| Electrical | 13 | 10 | 12 | 11 | 12 | 15 | 21 |
| performance | | | | | | | |
| of driver | | | | | | | |
| clear (current | | | | | | | |
| ≤20 μA) | | | | | | | |
| Driver clear | 449 | 445 | 505 | 468 | 454 | 475 | 527 |
| delay | | | | | | | |
| Partial | Yes | Yes | Yes | Yes | Yes | Yes | Yes |
| erasing is | | | | | | | |
| complete or | | | | | | | |
| not? | | | | | | | |
| The voltage | No | No | No | No | No | Yes | No |
| has to be | | | | | | | |
| maintained | | | | | | | |
| continuously | | | | | | | |
| or not during | | | | | | | |
| partial | | | | | | | |
| erasing? | | | | | | | |
| Transmission | Yes | Yes | Yes | Yes | Yes | Yes | No |
| and storage | | | | | | | |
| functions are | | | | | | | |
| qualified or | | | | | | | |
| not? | | | | | | | |
| Overall effect | 83 | 97 | 88 | 95 | 94 | 80 | 60 |
| score (full | | | | | | | |
| marks: 100) | | | | | | | |

As can be seen from Table 1, the writing film made of the liquid crystal layer containing the code-point carbon element capsule array in the present invention can achieve the partial erasing function of the display, as well as transmission and storage functions. In Examples 1-4, due to addition of the magnetic microcapsule, partial erasing can be realized regardless of whether the voltage is maintained continuously. However, in Example 6, because no magnetic microcapsule is added, the voltage has to be maintained all the time to realize partial erasing, resulting in a decrease in the overall effect score of the product. This proves that the addition of magnetic microcapsule can enhance the stability of the writing film structure, improve the clarity and contrast of the handwriting, and is more conducive to rapid partial erasing.

In Example 1, no code-point carbon element is printed on the inner surface of the first conductive layer. In Example 3, the amount of code-point carbon element printed on the inner surface of the first conductive layer is insufficient. Although the transmission and storage functions are still achieved, the clarity and contrast of the handwriting decrease, and the overall effect scores decrease seriously.

In Comparative Example 1, because no code-point carbon element capsule is added to the cholesteric liquid crystal composition, satisfactory transmission and storage functions cannot be achieved.

What is claimed is:

1. A color semi-transparent partially erasable electronic writing film with code points, characterized by, comprising: a first conductive layer, an intermediate layer and a second conductive layer which are stacked in sequence, wherein the intermediate layer is a liquid crystal layer containing a code-point carbon element capsule array, which is obtained by free filling of a cholesteric liquid crystal composition between the first conductive layer and the second conductive layer, followed by UV curing and integral forming; and
the cholesteric liquid crystal composition comprises the following raw materials in percent by mass: 75% to 85% of a nematic cholesteric liquid crystal, 1% to 10% of a code-point carbon element capsule, 4% to 15% of a UV adhesive and 0.1% to 0.3% of an isolation space powder; and
the first conductive layer and the second conductive layer are transparent conductive electrode film layers made of an indium tin oxide (ITO) or a conductive polymer.

2. The color semi-transparent partially erasable electronic writing film with code points according to claim 1, characterized in that, the nematic cholesteric liquid crystal is an RGB color cholesterol single liquid crystal mixture; and
the code-point carbon element is graphite and/or carbon black obtained through the combustion and gasification process of petroleum or natural gas; and
the code-point carbon element capsule is a microcapsule made by encapsulating the code-point carbon element in a water capsule shell material such as gelatin and/or glycerin, and the particle size of the microcapsule is 0.1-0.5 μm.

3. The color semi-transparent partially erasable electronic writing film with code points according to claim 1, characterized in that, the UV adhesive is a polyurethane acrylic polymer; and
the isolation space powder is a white polydivinylbenzene polymer with a uniform particle size of 1-10 μm, and a coefficient of variation of at most 2.00%.

4. The color semi-transparent partially erasable electronic writing film with code points according to claim 1, characterized in that, the UV curing refers to curing by polymerization and cross-linking reaction under UV irradiation at a temperature of 30-40° C., a pressure of 4-5 MPa, and a UV intensity of 3.5-5cd.

5. The color semi-transparent partially erasable electronic writing film with code points according to claim 1, characterized in that, the cholesteric liquid crystal composition further comprises 3% to 7% of a magnetic microcapsule.

6. The color semi-transparent partially erasable electronic writing film with code points according to claim 5, characterized in that, the magnetic microcapsule is a microcapsule made by encapsulating a magnetic particle in a microcapsule; and
the magnetic particle comprises one or more of ferroferric oxide powder, ferrite powder, and alloy magnetic powder, with a particle size of 0.1-3 μm; and
the percent of the magnetic microcapsule in the cholesteric liquid crystal composition is 5%-7%.

7. The color semi-transparent partially erasable electronic writing film with code points according to claim 5, characterized in that, the cholesteric liquid crystal composition comprises: 80% of the nematic cholesteric liquid crystal, 8% of the code-point carbon element capsule, 5% of Hongyangde UV adhesive, 0.2% of the isolation space powder and 6.8% of the magnetic microcapsule.

8. A color semi-transparent partially erasable electronic display with code points, characterized by, comprising at least one first carrier layer and at least one second carrier layer, wherein the color semi-transparent partially erasable electronic writing film with code points according to claim 1 is sandwiched between the first carrier layer and the second carrier layer, the first carrier layer is a transparent nano-sized PET conductive film, and the second carrier layer is a transparent or non-transparent nano-sized PET conductive film.

9. The color semi-transparent partially erasable electronic display with code points according to claim 8, characterized in that, the first conductive layer of the color semi-transparent partially erasable electronic writing film with code points is a transparent conductive layer obtained by directly applying an indium tin oxide (ITO) or a conductive polymer to an inner surface of the first carrier layer by; and
the second conductive layer is a transparent conductive layer obtained by directly applying an indium tin oxide (ITO) or a conductive polymer to an inner surface of the second carrier layer.

10. The color semi-transparent partially erasable electronic writing film with code points according to claim 8, characterized in that, on an outer surface of the first carrier layer away from the first conductive layer or/and an outer surface of the second carrier layer away from the second conductive layer, or/and a surface of the first conductive layer or/and the second conductive layer facing the intermediate layer, a code-point carbon element is printed; and
the coverage area of the code-point carbon element is at least 80% of the total area of the printed layer.

11. The color semi-transparent partially erasable electronic display with code points according to claim 8, characterized in that, the outer surface of the second carrier layer of the color semi-transparent partially erasable electronic display with code points is also provided with a semi-transparent coating.

12. The color semi-transparent partially erasable electronic display with code points according to claim 8, characterized in that, an electronic circuit is arranged between the first conductive layer and the second conductive layer, and a voltage is applied to the conductive layer; and
the voltage is applied as a voltage pulse or a continuous voltage.
